(19) United States
(12) Patent Application Publication
(10) Pub. No.: US 2003/0074438 A1
(43) Pub. Date: Apr. 17, 2003

(54) Techniques for enabling an internet services provider to perform office operations and functions

(75) Inventors: David A. Baldwin, Rockville, MD (US); Brian S. Hak, Bethesda, MD (US)

Correspondence Address: Ensoport Internetworks, 2401 Pennsylvania Ave., NW 300, Washington, DC, 20037, US

(73) Assignee: Ensoport Internetworks, Washington, DC

(21) Appl. No.: 09/976,090

(22) Filed: Oct. 15, 2001

(51) Int. Cl. G06F 15/173

(52) U.S. Cl. 709/224; 705/26

(57) ABSTRACT

A system for defining, implementing, and maintaining geographically disperse Internet Service Providers (ISP) from a centralized processing center. Customers of ISP are provisioned services that include, but are not limited to, internet access, e-mail access, and web-hosting space. System provides ability to define flexible service offerings at price points dependent on disparate market conditions. Further, the system generates billing data based on specified service offerings that is aggregated and presented to the customer in a formatted bill in local currency and in accordance to local customs. Collection for services rendered is performed by the system in conjunction with third party processing systems in local currencies.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

1. Field of the Invention

This invention relates to back office management needs of an ISP. More specifically, to the creation, provisioning, billing, and collection of services offered by an ISP.

2. Description of Prior Art

### U.S. Patent Documents

| | | |
|---|---|---|
| 5852812 | August 1995 | Reeder |
| 6266401 | September 1998 | Marchbanks et al. |
| 5893077 | August 1995 | Griffin |
| 6104704 | August 2000 | Buhler, et al. |

Owning and operating an ISP is typically a task that demands substantial in-house staffing and technical expertise. Specifically, running an ISP that provisions multiple service offerings to hardware platforms that are physically distributed throughout the world, and billing and collecting for internet services rendered on these hardware platforms, is an involved procedure that requires considerable man-hours on a repeating basis. There exists a need to simplify the process for managing an ISP whose locations are geographically distributed, whose service offerings and price points are dependant of market conditions, and whose billing process requires multiple currencies. The present invention fulfills these and other needs.

### BRIEF SUMMARY OF THE INVENTION

The present invention is comprised of four major components:

a) A toolset for creating various ISP service offerings based on differing market conditions

b) A system for provisioning said services to various hardware platforms over a data network

c) A system for billing said services in multiple currencies based on geographic location

d) A toolset for collecting and settling payment for said services in multiple currencies

It is noted that the present invention relies of several existing technologies to achieve its functionality. The technologies needed for the system to be functional in any embodiment are comprised of the following:

a) A relational database system for storage of persistent data

b) A computer data network capable of communication through the internet

c) The Sun J2EE computing platform

The above summary is not intended to fully describe each embodiment or every implementation of the present invention. A more thorough understanding of the invention will be achieved and appreciated by referring to the following detailed description in conjunction with the accompanying drawings and listed claims.

### BRIEF DESCRIPTION OF THE SEVERAL VIEWS OF THE DRAWING

FIG. 1 is an illustration of the centralized data processing center and its relation to geographically distributed hardware platforms.

FIG. 2 illustrates a desired embodiment of the components that comprise the central data processing center

FIG. 3 is a high level illustration of data flow through the system

FIG. 4 is an illustration of a possible Rate Calendar that defines internet access cost for a specific ISP point of presence

FIG. 5 is a detailed illustration of the flow through the ISP service provisioning system

FIG. 6 illustrates in detail the ISP service billing system

### DETAILED DESCRIPTION OF THE INVENTION

In the following description of the illustrated embodiments, references are made to the accompanying drawings which form a part hereof, and in which is shown by way of illustration, various embodiments in which the invention may be practiced. It is to be understood that other embodiments may be utilized, and structural and functional changes may be made without departing from the scope of the present invention.

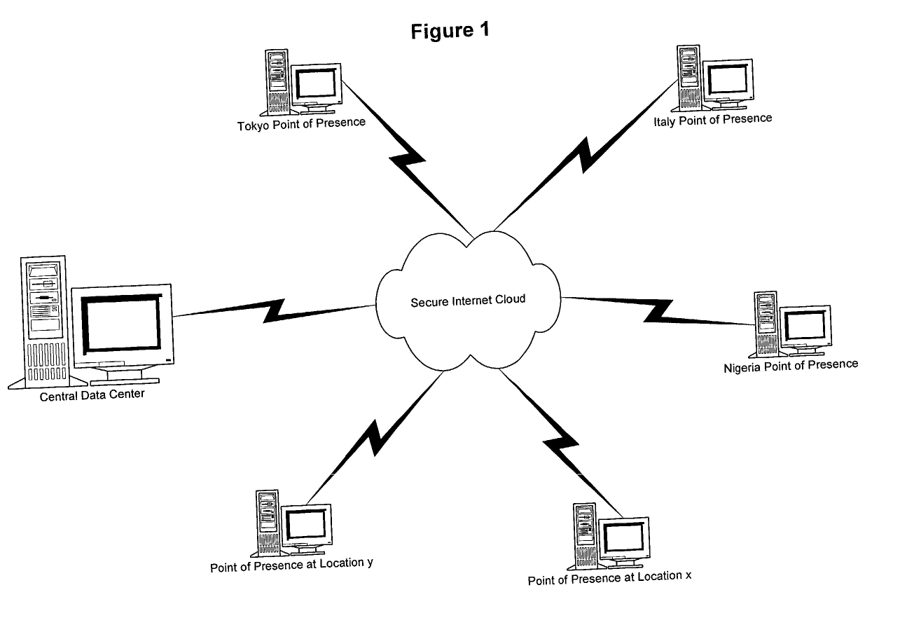

Referring now to the diagrams, and more specifically to FIG. 1, there is illustrated a generalized diagram of the relationship between the central data processing center and distributed hardware platforms. In order to eliminate redundancies is staffing, technical expertise, and computer hardware which induce high operating budgets for ISP operators, all data processing is accomplished at a central data center. The data center systems communicate through a secure data network to various ISP points of presence. Only data that is needed for customers to access services is transferred across the data network, thus reducing network overhead and limiting the amount of computer hardware needed to be located at each point of presence. All computation in regard to billing, collection, service provisioning and service creation is performed on hardware and software that reside in the central data center.

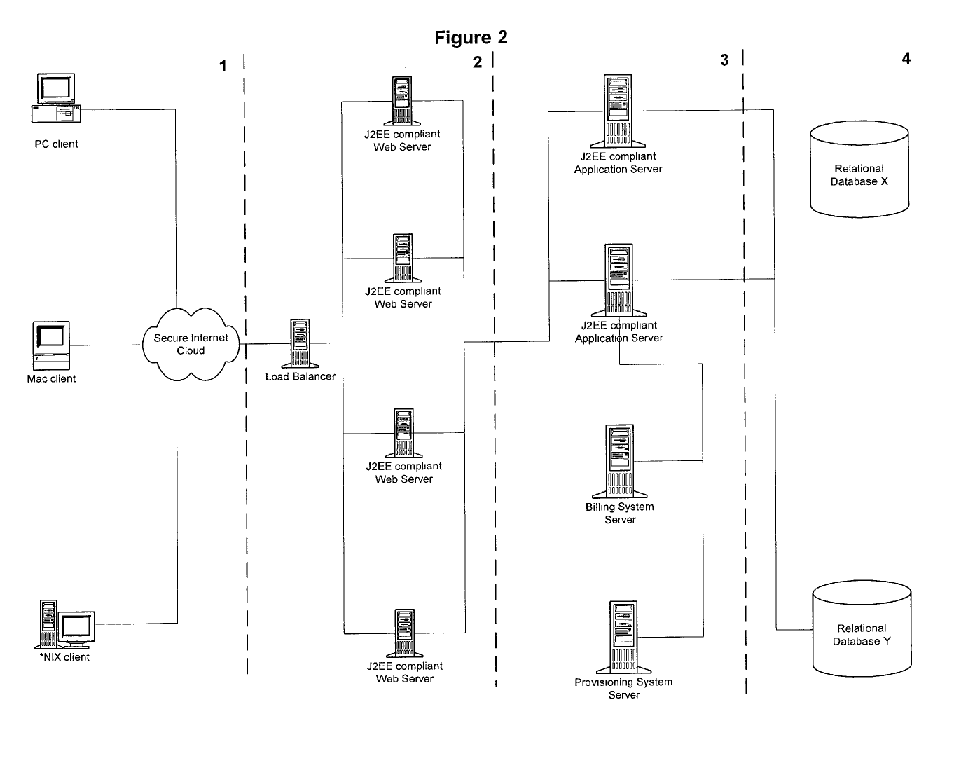

Considering FIG. 2 there is illustrated an embodiment of the computing platform that will reside at the central data center. Data is processed beginning at 1 where data is input to the system via a secure web page over the internet. Presentation of data entered is then rendered at 2 via web servers and J2EE software that is included in the scope of the present invention. At 2, the J2EE software responsible for data rendering will display information in a localized format (including, but not limited to, local language) depending on the geographic location of the client connecting to the system at 1. Data is then passed to the application layer, 3, where J2EE software performs business logic to compute needed quantities and then passes them to 4 for persistent storage. It should be noted that the optimal embodiment of data center hardware will have provisions for redundancy and scalability throughout, as depicted in FIG. 2.

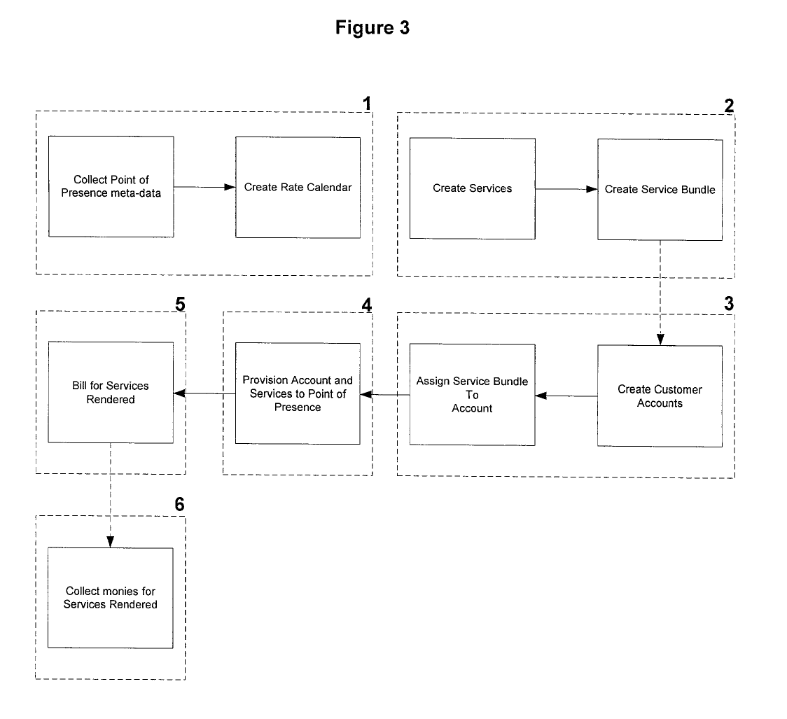

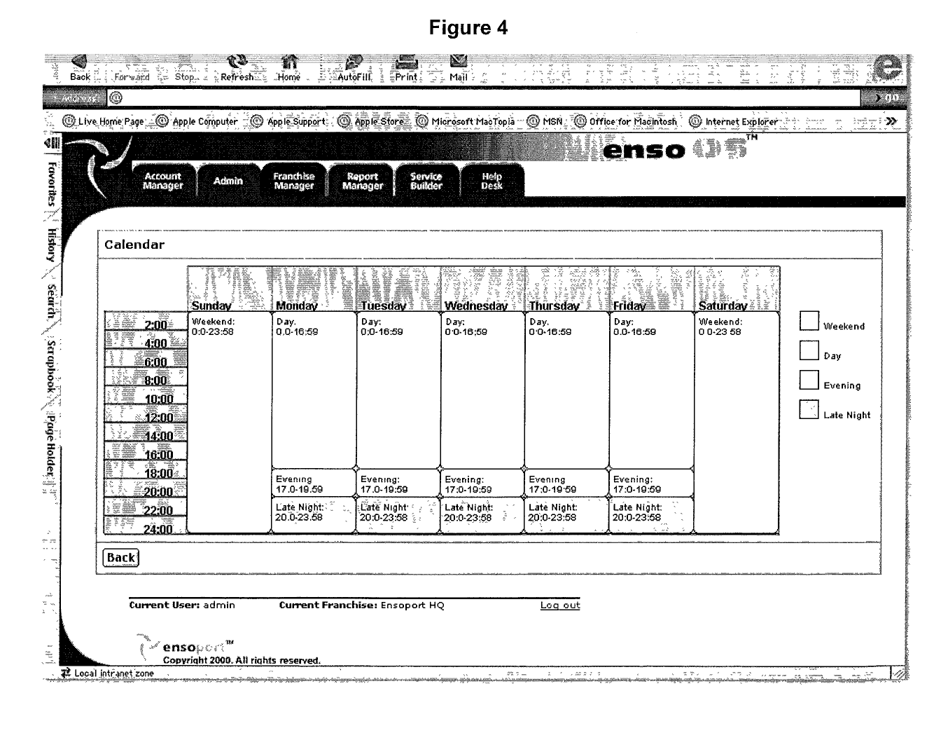

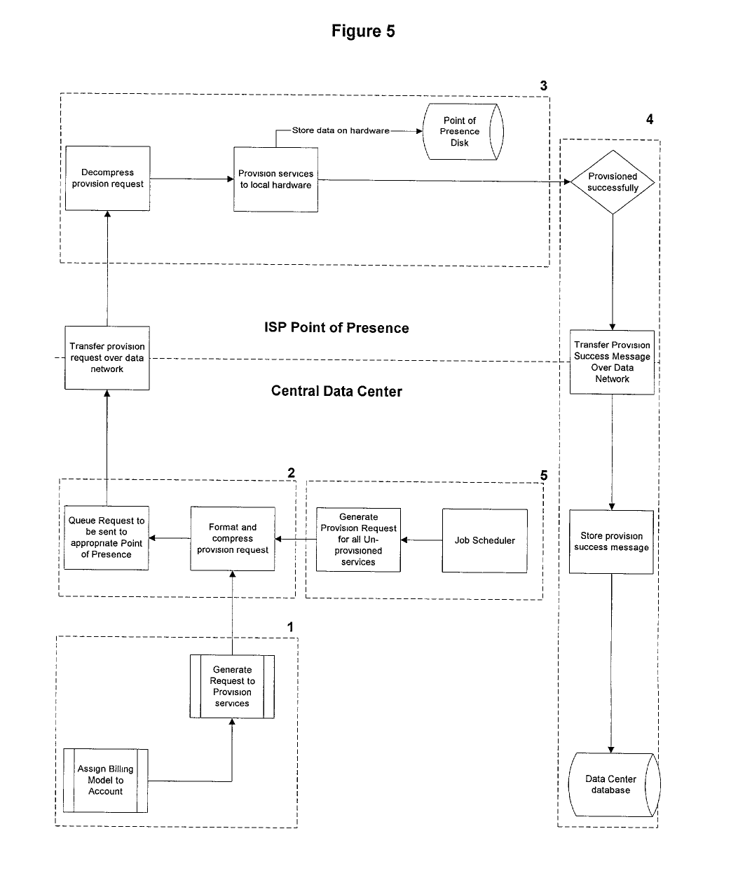

FIG. 3 depicts a high level flow of data through the system. A point of presence is first defined at 1 by entering needed meta-data describing, among other things, geographic location and currency of the point of presence. Also at 1, the definition of services begins. An entity termed a rate calendar (FIG. 4) is constructed by entering data for costs of internet access at various points of a calendar week based on current market conditions. The rate calendar defines the basis upon which all internet access services are then built for each point of presence. At 2, definition of service offerings is further defined. Each service to be offered from the point of presence is defined with appropriate meta-data (i.e. Quota in MB of an e-mail account, amount of internet access time allowed, etc). Various services are then bundled together at 2 and assigned a single price point at which the group of services will be offered to the customer. At 3, meta-data is collected about customer accounts (i.e. Login, name, address, etc), and then assigned a group of services created at 2. Data from 3 is passed to the provisioning system at 4 (further detailed in FIG. 5) that communicates with appropriate point of presence of a secure data network to provide services assigned to customer at 3.

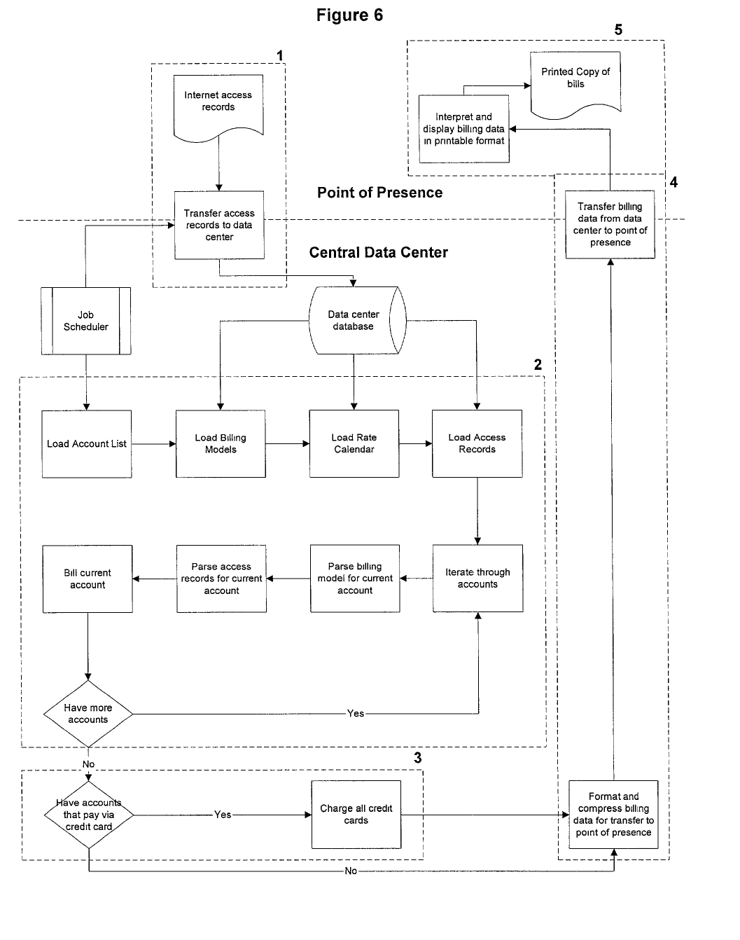

Periodically, billing processes are run by the billing system (further detailed in FIG. 6) to generate bills for services rendered in the local currency of the customer. Finally, payment is collected at 6 by the bill collection system.

FIG. 5 illustrates in detail the workings of the provisioning system. Data enters into the system initially at 1 as a request from the account creation process (FIG. 3). Information is then queued for service in a first in first out (FIFO) manner and awaits transfer to the point of presence a 2. Also at 2, data is compressed to minimize network traffic when transferring data to the point of presence. At 3, a component of the provisioning system listens at each point of presence for requests from the central data center. When a request to provision services for a customer is received, its payload is decompressed and then stored on the local hardware so a customer may access their services. If and only if services are successfully stored on local hardware, a confirmation message, at 4, is transmitted back across the secure data network to the central data center where a record of the success is stored for future reference. At 5, an independent component of the provisioning system periodically attempts to resend requests to points of presence for service provisioning that has previously failed.

FIG. 6 provides a detailed illustration of the billing system. At 1, internet access records are collected periodically from each point of presence and transferred to the central data center. At the data center, one component of the billing system parses the detail records and stores them for processing at 2. At 2, a component of the Billing system is run periodically to calculate amount due for services rendered to customers. This billing process is comprised of first loading the billing model (i.e. Bundle of service offerings) for each customer and the rate calendar for the current point of presence. Based on information contained in a customers billing model, the amount of money owed to the ISP operator by the customer is computed. Once monies owed have been computed for a given customer, the billing system determines whether or not the customer pays for services with a credit card. If so, it communicates with a 3^{rd} party credit processing system at 3 to appropriately charge the amount due for services rendered to the customers credit account. Next, all billing data is compressed, and sent to the appropriate point of presence at 4. Once billing data for all customers has been received, a final component of the Billing system localizes the compressed data and generates a printable bill that the customer will receive at 5.

The present invention streamlines and automates the processing of operating an ISP by centralizing the storage and processing of data. Further, it allows for localization of services at market dependant price points and provides billing and collection services in currencies local to a given point of presence.

We claim:

2. A method for creating ISP service offerings that group a) world wide web (WWW) internet access, b) electronic mail access, c) internet web hosting space, and d) future ISP service offerings that can be collected upon as either i) a flat rate recurring revenue or ii) a fluctuating recurring revenue based upon usage patterns.

3. The method of claim 1, wherein users interact with the system through localized graphical user interface (GUI).

4. A system for provisioning services defined in claim 1.

5. The system of claim 3, wherein services are provisioned from a central data center.

6. The system of claim 3, wherein services are provisioned over a data network to geographically disperse sets of specified hardware.

7. A billing system to create a cohesive bill statement based upon the service offerings defined in claim 1.

8. The system of claim 6, wherein customers are billed in local currency.

9. The system of claim 6, wherein customers are presented with localized bill.

10. The system of claim 6, wherein multiple billing periods may be defined.

11. The system of claim 6, wherein the each billing period may have a differing length.

12. A collection system for managing collections against bills generated in accordance to claim 6.

13. The system of claim 11, wherein credit card transactions are automatically processed by transfer to a third party credit card processing system.

14. The system of claim 11, wherein cash and check transactions are authorized by a third party vendor and collection information is stored in the system.
